(19) United States
(12) Patent Application Publication
(10) Pub. No.: US 2022/0358712 A1
(43) Pub. Date: Nov. 10, 2022

(54) METHOD AND SYSTEM FOR SYNTHESIZING NOVEL VIEW IMAGE ON BASIS OF MULTIPLE 360 IMAGES FOR 6-DEGREES OF FREEDOM VIRTUAL REALITY

(71) Applicant: Korea Advanced Institute of Science and Technology, Daejeon (KR)

(72) Inventors: Woontack Woo, Daejeon (KR); Hochul Cho, Daejeon (KR)

(73) Assignee: Korea Advanced Institute of Science and Technology, Daejeon (KR)

(21) Appl. No.: 17/630,498

(22) PCT Filed: Feb. 18, 2020
(86) PCT No.: PCT/KR2020/002289

§ 371 Date: Jul. 20, 2022

(30) Foreign Application Priority Data
Oct. 21, 2019 (KR) 10-2019-0130335

(51) Int. Cl. G06T 15/20; G06T 17/20

(52) U.S. Cl. CPC G06T 15/20; G06T 17/205

(57) ABSTRACT

A method and a system for synthesizing a novel-view image based on multiple 360 images for 6DOF virtual reality, in which a large-scale 6-DOF virtual environment is implemented, and a scene is synthesized at a novel viewpoint, are provided. The method includes performing a 3D reconfiguration procedure for the 360 images to recover 3D geometric information, and to reconfigure a virtual data map in which the multiple 360 images are integrated into one image, producing a view image corresponding to a viewpoint of a user by applying a view synthesis algorithm of projection & vertex warping process using a reference image which is closest to a viewpoint extracted from the virtual data map, and blending view images for 6DoF through a section formula for inner split based on a distance between a position of the reference image and a position of the viewpoint.

### TECHNICAL FIELD

The present disclosure relates to a method for synthesizing a novel-view image based on multiple 360 images for 6DoF virtual reality, and a system for the same, and more particularly, relates to a technology of implementing a large-scale 6DoF virtual environment using multiple 360 images and synthesizing a scene at a novel viewpoint.

### BACKGROUND

To allow a user to experience an immersive virtual reality, 6DoF movement should be supported such that the user more widely makes mutual interaction and actively takes part in the experience, and unreality and motion sickness caused by the mismatch between visual feedback and real movement is reduced. However, most part VR content made by using a 360 camera supports only 3DoF rotation, due to insufficient sensor information on a reality to create a 6DoF virtual environment and the technical difficulty in implementing a virtual environment.

The 6 degree of freedom (6DoF) virtual environment refers to an environment allowing a user to freely move and look around, because the 6DoF virtual environment has the degree of freedom with respect to three rotation axes and three position axes. To implement the 6DoF virtual reality system, a technology of synthesizing a novel view image is required to synthesize a view matched to a place which is not photographed, when the user moves the place.

However, according to a conventional method for changing a reality to a virtual reality by using a 3D model, the 6DoF supporting free movement is provided, but the sense of reality is degraded due to graphic quality degraded.

According to another conventional method for changing a reality to a virtual reality by using a 360 camera, graphic is provided with the sense of reality due to the use of a real photo, but a user cannot freely move because the 6DoF is not supported. Accordingly, a method for implementing the 6DoF environment allowing free movement of the user while providing the graphic with the sense of reality.

To implement the 6DoF environment, the two conventional methods are employed.

First, conventionally, a novel-view synthesis method is attempted to implement the 6DoF environment based on an image through an image-based rendering technology. However, the related art, which is to synthesize a novel-view image using a typical 2D image, is not studied regarding a technology of synthesizing a novel view image using 360 images including information on a wider area. Second, a novel-view synthesis method is attempted using 360 images. However, according to the related art, although a method of applying the degree of freedom to a single image is suggested, the problem caused when several sheets of images are synthesized to implement the virtual environment of a wider space is not solved. Accordingly, there is required a synthesis method effective more than a method for using several sheets of images, to implement the 6DoF environment with respect to a wider space using the 360 images.

### SUMMARY

### Techinical Problem

The present disclosure is to provide a novel view synthesis process for reconfiguring a large-scale virtual data map based on a reality to process a plurality of 360 image serving as reference images, and for performing weighted blending to interpolate a plurality of view images.

The present disclosure is to implement a large-scale 6DoF VR system having multiple 360 images for synthesizing a novel view image of a reference image through an image projection and warping process for a sphere mesh having a triangular surface and a plurality of vertexes by sub-dividing the Icosahedron sphere several times, and for interpolating the images into one complete novel view image.

The present disclosure is to implement a large-scale 6DoF VR environment without the loss of an image quality based on a distance, as well as the smooth switching between 360 images.

### Technical Solution

According to an aspect of the present disclosure, a method for synthesizing a novel-view image based on multiple 360 images for 6DOF virtual reality, includes performing a 3D reconfiguration procedure for the 360 images to recover 3D geometric information, and to reconfigure a virtual data map in which the multiple 360 images are integrated into one image, producing a view image corresponding to a viewpoint of a user by applying a view synthesis algorithm of projection & vertex warping process using a reference image which is closest to a viewpoint extracted from the virtual data map, and blending view images for 6DoF through a section formula for inner split based on a distance between a position of the reference image and a position of the viewpoint.

The reconfiguring of the virtual data map may include reconfiguring the virtual data map, which is a reference sphere of a sphere mesh having a triangular surface and a plurality of vertexes by subdividing a Icosahedron sphere several times, with respect to the 360 images.

The reconfiguring of the virtual data map may include performing the 3D reconfiguration in a structure from motion (SfM) scheme for view synthesis based on the multiple 360 images, and reconfiguring the virtual data map in which the 3D geometric information is integrated into one image.

The 3D geometric information may include a point cloud for the 360 images, a 3D mesh based on the point cloud, and an external parameter group (a camera location) of a camera, which indicates a posture of the camera.

The producing of the view image may include acquiring the viewpoint corresponding to each vertex of the virtual data map by using the reference image mapped to the reference sphere, and acquiring a position, in which the vertex is moved, as the viewpoint is projected to a novel sphere inducing movement of pixels by moving vertexes of the reference sphere to the acquired position, and producing the view image corresponding to a field-of view at a user viewpoint by positioning a camera into the novel sphere.

The acquiring of the viewpoint and the position may include using a single reference image closest to the viewpoint or two reference images closes to the viewpoint.

The blending of the view image includes employing a weighted blending scheme for blending pixels inversely proportional to the distance, with respect to at least two reference images, to prevent an environment of the reference image from being switched.

The blending of the view image includes calculating pixel values of the view image at the final stage through the section formula, after acquiring a distance between the novel sphere and the reference sphere to perform the weighted blending scheme for the pixels.

The section formula is an equation for acquiring weighted blending.

According to another aspect of the present disclosure, in a computer program stored in a computer-readable medium to execute a method for synthesizing a novel-view image based on multiple 360 images for 6DOF virtual reality, the method for synthesizing the novel-view image based on the multiple 360 images for the 6DOF virtual reality, includes performing a 3D reconfiguration procedure for the 360 images to recover 3D geometric information, and to reconfigure a virtual data map in which the multiple 360 images are integrated into one image, producing a view image corresponding to a viewpoint of a user by applying a view synthesis algorithm of projection & vertex warping process using a reference image which is closest to a viewpoint extracted from the virtual data map, and blending view images for 6DoF through a section formula for inner split based on a distance between a position of the reference image and a position of the viewpoint.

According to another aspect of the present disclosure, a system for synthesizing a novel-view image based on multiple 360 images for 6DOF virtual reality, the system comprising includes a reconfiguring unit to perform a 3D reconfiguration procedure for the 360 images to recover 3D geometric information, and to reconfigure a virtual data map in which the multiple 360 images are integrated into one image, a processing unit to generate a view image corresponding to a viewpoint of a user by applying a view synthesis algorithm of projection & vertex warping process using a reference image which is closest to a viewpoint extracted from the virtual data map, and a blending unit to blend view images for 6DoF through a section formula for inner split based on a distance between a position of the reference image and a position of the viewpoint.

The reconfiguring unit may reconfigure the virtual map, which is a reference sphere of a sphere mesh having a triangular surface and a plurality of vertexes by subdividing a Icosahedron sphere several times, with respect to the 360 images.

The reconfiguring unit may perform the 3D reconfiguration in a structure from motion (SfM) scheme for view synthesis based on the multiple 360 images, and may reconfigure the virtual data map in which the 3D geometric information is integrated into one image.

The processing unit may include an acquiring unit to acquire the viewpoint corresponding to each vertex of the virtual data map by using the reference image mapped to the reference sphere, and acquire a position, in which the vertex is moved, as the viewpoint is projected to a novel sphere, a pixel unit to induce movement of pixels by moving vertexes of the reference sphere to the acquired position, and a generator to generate the view image corresponding to a field-of view at a user viewpoint by positioning a camera into the novel sphere.

The acquiring unit may use a single reference image closest to the viewpoint or two reference images closes to the viewpoint.

The blending unit may employ a weighted blending scheme for blending pixels inversely proportional to the distance, with respect to at least two reference images, to prevent an environment of the reference image from being switched.

The blending unit may calculate pixel values of the view image at the final stage through the section formula, after acquiring a distance between the novel sphere and the reference sphere to perform the weighted blending scheme for the pixels.

### Advantageous Effects of the Invention

According to an embodiment of the present disclosure, the multiple 360 images serving as the reference images are processed by reconfiguring the virtual data map based on the large-scale reality, thereby synthesizing a novel view through weighted blending to interpolate the plurality of novel view images.

In addition, according to the present disclosure, the large-scale 6DoF VR system having multiple 360 images may be implemented by synthesizing the novel view image of a reference image through an image projection and warping process for a sphere mesh having a triangular surface and a plurality of vertexes by sub-dividing the Icosahedron sphere, which has a triangular surface, several times, and by interpolating the images into one complete novel view image.

In addition, according to the present disclosure, the large-scale 6DoF VR environment may be implemented without the loss of the image quality based on the distance, as well as the smooth switching between 360 images.

### DESCRIPTION OF THE DRAWINGS

FIG. 1 illustrates a flowchart of the operation of a method for synthesizing a novel-view image based on multiple 360 images for 6DOF virtual reality, according to an embodiment of the present disclosure;

FIG. 2 illustrates a schematic view of a method for synthesizing a novel-view image based on multiple 360 images for 6DOF virtual reality, according to an embodiment of the present disclosure;

FIG. 3 illustrates a process of implementing a sphere mesh having a triangular surface and a plurality of vertices by sub-dividing a Icosahedron sphere several times, according to an embodiment of the present disclosure;

FIG. 4 illustrates a projection & vertex warping process, according to an embodiment of the present disclosure;

FIG. 5 illustrates a weighted blending process, according to an embodiment of the present disclosure;

FIGS. 6A and 6B illustrate experimental examples for evaluating a method for synthesizing a novel-view image based on multiple 360 images for 6DOF virtual reality, according to an embodiment of the present disclosure;

FIGS. 7 and 8 illustrate graphs of results for the experiments performed as illustrated in FIG. 6; and

FIG. 9 illustrates a block diagram of the detailed configuration of a system for synthesizing a novel-view image based on multiple 360 images for 6DOF virtual reality, according to an embodiment of the present disclosure.

### DESCRIPTION

Hereinafter, exemplary embodiments of the present disclosure will be described in detail with reference to the accompanying drawings. However, the present disclosure is not limited or restricted by the embodiments. Further, the same reference signs/numerals in the drawings indicate the same members.

Furthermore, the terminologies used herein are used to properly express the embodiments of the present disclosure, and may be changed according to the intent of a viewer or an operator in the field to which the present disclosure pertains. Accordingly, definition of the terms should be made according to the overall disclosure set forth herein.

The subject matter of the present disclosure is to provide a method for synthesizing a user view image in real time, enabling the user to experience a 6DoF in a wider space.

In particular, the subject matter of the present disclosure is to construct a large-scale 6DOF virtual environment by using multiple 360 images, and to synthesize scenes at a novel viewpoint. When a user view is synthesized based on a single 360 image in real time, a user may freely experience a view through a complete head motion of a 6DoF, but a space, in which the user is movable, is confined within an image context. Therefore, the present disclosure suggests a process of minimizing an error of a synthesizing result by considering the multiple 360 images and by performing weighted blending, as the virtual data map based on reality in a wider space is reconfigured.

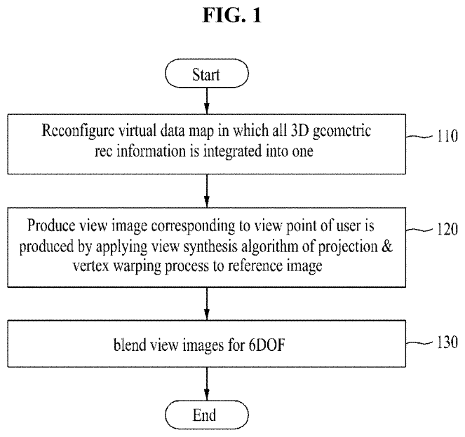

Hereinafter, a method for synthesizing a novel-view image based on multiple 360 images for 6DOF virtual reality allowing the experience of a virtual environment in a wider area and providing smooth switching between 360 images, and a system for the same will be described in detail with reference to FIGS. 1 to 9.

FIG. 1 illustrates a flowchart of the operation of a method for synthesizing a novel-view image based on multiple 360 images for 6DOF virtual reality, according to an embodiment of the present disclosure.

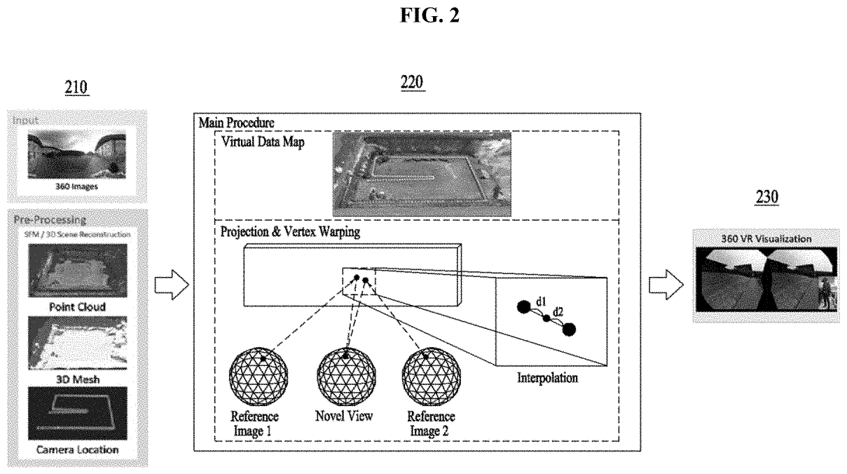

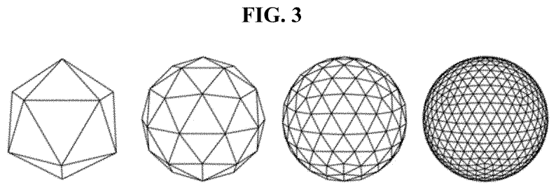

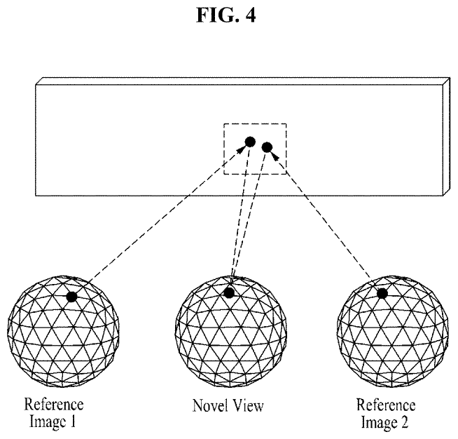

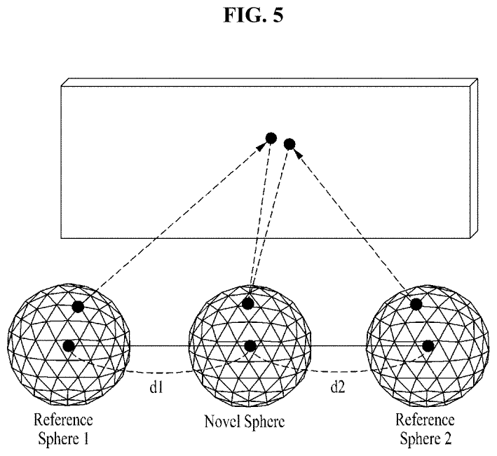

Hereinafter, a method for synthesizing a novel-view image based on multiple 360 images for 6DOF virtual reality will be described with reference to FIGS. 1, and FIGS. 2 to 5, in detail according to an embodiment of the present disclosure. In this case, FIG. 2 is a schematic view illustrating the method for synthesizing a novel-view image based on multiple 360 images for 6DOF virtual reality, according to an embodiment of the present disclosure. FIG. 3 is a view illustrating the process of implementing a sphere mesh having a triangular surface and a plurality of vertexes by sub-dividing a Icosahedron sphere several times, according to an embodiment of the present disclosure. In addition, FIG. 4 illustrates a projection and vertex warping process, according to an embodiment the present disclosure, and FIG. 5 illustrates a weighted blending process, according to an embodiment of the present disclosure.

Referring to FIGS. 1 and 3, step 110 and step 210 are to reconfigure 360 images to three-dimension (3D) images to recover 3D geometric information, and reconfigure a virtual data map in which the multiple 360 images are integrated into one image. The 360 images represent 360-degree images. In the present disclosure, the 360 images will be employed.

In step 110 and step 210, the 3D reconfiguration procedure, such as a structure from motion (SfM) procedure serving as a pre-processing procedure may be performed, to recover the 3D geometric information of scenes, which are necessary for view-synthesis, from the multiple 360 images. In this case, the estimated 3D geometric information may include a point cloud for 360 images, a 3D mesh based on the point cloud, and an external parameter group (a camera location) of a camera, which indicates the posture of the camera.

Thereafter, step 110 is to reconfigure a virtual data map in which all 3D geometric information is integrated into one.

Referring to FIG. 3, according to an embodiment of the present disclosure, regarding step 110 in the method for synthesizing a novel-view image based on multiple 360 images for 6DOF virtual reality, a sphere mesh having a triangular surface and a plurality of vertexes may be reconfigured by sub-dividing a Icosahedron sphere several times in step 110. The sphere mesh having numerous vertices is used to express the moving of a pixel in the vertex warping process.

Accordingly, in step S110, the virtual map is reconfigured on a reference sphere (a sphere positioned at the rightmost part of FIG. 2) serving as the sphere mesh, and a projection & vertex warping process is performed on the sphere mesh in the following step of the present disclosure.

In step 120 and step 220, a view image corresponding to the viewpoint of the user is generated by applying a view synthesis algorithm of the projection & vertex warping process by using a reference image closest to a viewpoint extracted from the virtual data map.

In step 120, a novel view synthesis algorithm may be employed, based on at least one reference image after acquiring the virtual data map of the schemes. The reference image closet to the novel viewpoint should have a view the most view to a novel view. In this regard, in step 120, a method of employing the closest single reference image is described.

In more detail, step 120 may include the step (not illustrated) of acquiring a viewpoint corresponding to each vertex of the virtual data map by using the reference image mapped to the reference sphere, and acquiring a position, in which the vertex is moved, as the viewpoint is projected to the novel sphere, the step (not illustrated) of inducing the movement of pixels by moving the vertexes of the reference sphere to the acquired position, and the step of producing a view image corresponding to a field-of view at a user viewpoint by positioning the camera into the novel sphere.

In this case, in the step of acquiring the viewpoint and the position, a single reference image closest to the viewpoint or two reference images closes to the viewpoint may be used.

For example, referring to FIG. 4, in step 120 of performing the projection & vertex warping using the single reference image, an image closes to the novel view may be selected as a reference image, and the reference image may be mapped to the sphere mesh having a triangular surface and a plurality of vertexes by sub-dividing a Icosahedron sphere several times. When light is radiated from the center of a sphere through each vertex of the reference image, a novel viewpoint may be reflected (sun-casted), and a next reference vertex may be transformed to a vertex of a sphere of a novel viewpoint. As the vertexes are transformed, all pixels are mapped to the sphere, the sphere is moved for a novel view, and the novel view is generated.

Accordingly, in step 120, the viewpoint is projected to a novel sphere, the position, to which the vertex is moved, is acquired, and the vertexes of the reference images are moved to the relevant position, thereby inducing the movement of the pixels. Thereafter, in step 120, the novel view image may be generated through the sphere matched to the field of view of the display.

For another example, regarding the description, which is made with reference to FIG. 4, of step 120 for performing the projection & vertex warping by using two reference images, viewpoints in a three-dimension (3D) model corresponding to a vertex of reference image 1 and a vertex of reference image 2 are acquired, and the viewpoints are projected to the novel sphere, thereby acquiring positions to which the vertexes are moved. Thereafter, in step 120, 360 images are applied to the positions, that is, the vertexes of reference image 1 and reference image 2 are moved, thereby inducing the movement of pixels. Accordingly, in step 120, at the final image, the camera is positioned into the novel sphere, and the novel view image corresponding to the field-of-view at the user viewpoints may be generated.

In step 130, view images for 6DoF are blended through a section formula for inner split based on the distance between the position of the reference image and the position of the viewpoint.

In step 130, at least two reference images are considered, and a weighted blending scheme for blending pixels inversely proportional to the distance may be used to prevent a screen image, which is generated when the reference image is changed, from being switched.

In addition, in step 130, as illustrated in FIG. 5, for the weighted blending for the pixels, the distance between the novel sphere and reference sphere 1, and the distance between the novel sphere and reference 2 are acquired, and then, the pixel values of the view image may be calculated at the final stage through the section formula. In more detail, in step 130, after acquiring the distance between the novel sphere and the reference sphere 1, and the distance between the novel sphere and the reference sphere 2, the pixel values of the final novel-view image may be calculated through Equation 1 which is a section formula.

$${Pixel}_{Interpolated} ( x , y ) = \frac{{Pixel}_{novel 1} ( x , y ) \times {d}_{2} + {Pixel}_{novel 2} ( x , y ) \times {d}_{1}}{{d}_{1} + {d}_{2}} \qquad Equation 1$$

In this case, the section formula, which is Equation 1, may be an equation for weighted blending.

In Equation 1, d₁ and d₂ denote the distances between the novel sphere and the reference spheres, and Pixel Interpolated denote pixel values of novel view images generated based the reference sphere.

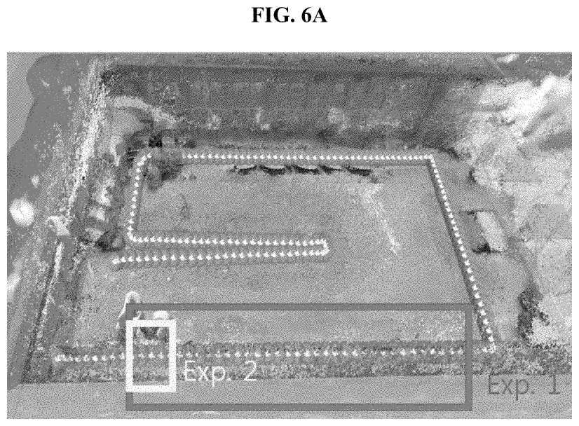

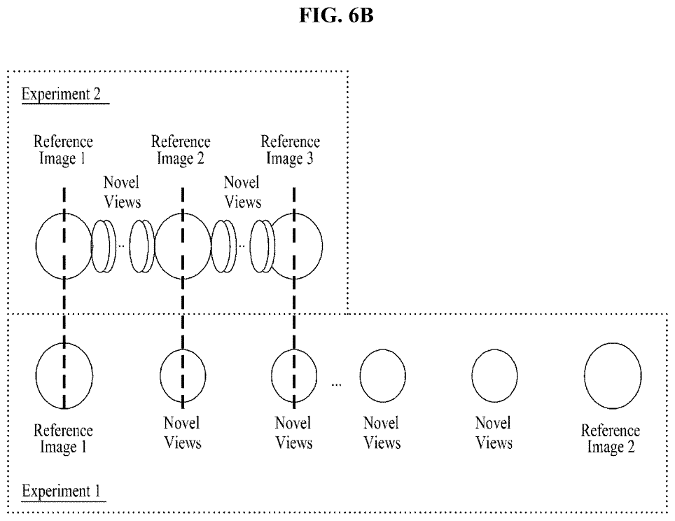

FIGS. 6A and 6B illustrate experimental examples for evaluating a method for synthesizing a novel-view image based on multiple 360 images for 6DOF virtual reality, according to an embodiment of the present disclosure.

In more detail, FIG. 6A is a view obtained by capturing a cloister of a building having the length of 70 m and the width of 35 m by using a GoPro Fusion 360 VR camera, and illustrates a virtual data map generated by using a tool employing a pipeline for measuring a photograph with respect to the total of 290 images which are captured.

In addition, FIG. 6B illustrates two experimental results obtained for evaluating the method for synthesizing a novel-view image based on multiple 360 images for 6DOF virtual reality, according to an embodiment of the present disclosure.

In Experiment 1 (Exp.1), the total of 22 images are synthesized at 22 points positioned between positions of the two reference images spaced apart from each other by 50 m. Thereafter, the synthesized images were compared with real-measured images through both a peak signal-to-noise ratio (PSNR) measuring scheme and a structural similarity metric (SSIM) measuring scheme.

In Experiment 2 (Exp.2), the total of 44 images and frames were synthesized at uniform distances between three reference images spaced apart from each other by 1.75 m. Next, the smoothness of all images (reference and synthesis) was evaluated by comparing a previous frame with each frame.

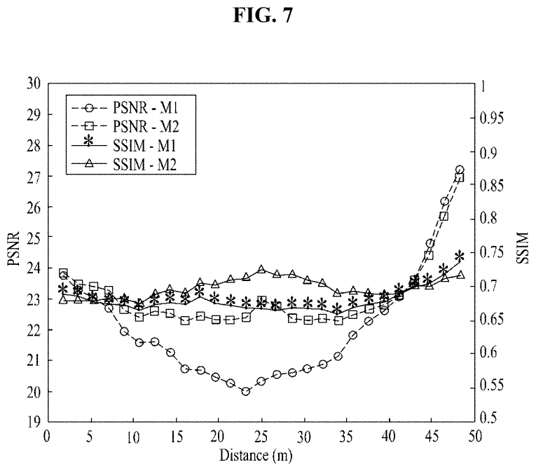

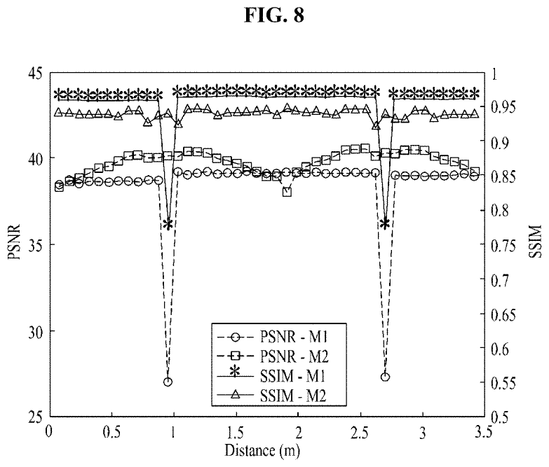

FIGS. 7 and 8 illustrate graphs of results for the experiments performed as illustrated in FIG. 6.

In more detail, FIG. 7 illustrates an experimental result representing the change of image quality of a view image at a novel viewpoint, depending on the distance to the reference image in the method of FIG. 6. In this case, as the viewpoint is moved from the first reference image to the second reference image, the image of the novel viewpoint was generated.

In FIG. 7, M1 (method 1) indicates Experiment 1 showing a result when the weighted blending scheme is not used, and M2 (method 2) indicates Experiment 2 showing a result when the weighted blending scheme is used. It may be recognized through FIG. 7 that the image quality of the synthesized image is maintained even a long distance to the reference image, when the weighted blending scheme is used

In detail, in the case of M1, it may be recognized that the image quality of the synthesized image is gradually reduced, as the distance to the reference image is increased up to 25 m, and, as the reference image is changed after the distance of 25 m, the image quality of the synthesized image is gradually recovered toward the changed reference image. To the contrary, in the case of M2, it may be recognized that the image quality is maintained, even though two reference images are interpolated and a novel view is away from the reference images,

Referring to FIG. 8, when the reference images are positioned at the distance of 1.75 m (first), and the distance of 3.5 m (second), screen images suddenly switched may be recognized through smoothness values rapidly dropped at the distances of 1 m and 2.75 m in which the reference images are changed, in the case of M1. To the contrary, in the case of M2, it may be recognized that the whole frame difference is constantly maintained by interpolating two reference images, and switching smoothness is maintained.

Therefore, in the method for synthesizing a novel-view image based on multiple 360 images for 6DoF virtual reality according to an embodiment of the present disclosure, the projection & warping scheme is utilized for a sphere by using the reconfigured 3D scenes, a desired view is synthesized based on a single 360 image, and the weighted blending is applied to the plurality of reference views to interpolate a plurality of synthesized views, thereby prospecting the growth of VR content based on 360 images through a 6DoF VR system according to the present disclosure.

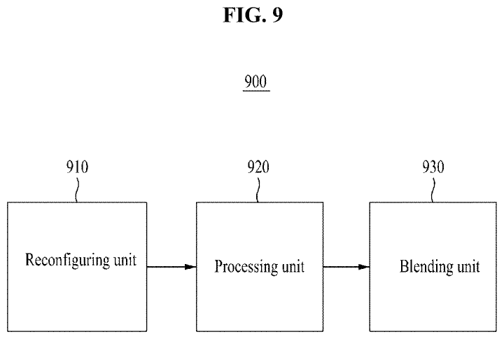

FIG. 9 is a block diagram illustrating the detailed configuration of a system for synthesizing a novel-view image based on multiple 360 images for 6DOF virtual reality, according to an embodiment of the present disclosure.

Referring to FIG. 9, the system for synthesizing a novel-view image based on multiple 360 images for 6DoF virtual reality implements the large-scale 6DoF virtual environment and synthesizes a scene at a novel viewpoint by using the multiple 360 images, according to an embodiment of the present disclosure.

To this end, a system 900 for synthesizing a novel-view image based on multiple 360 images for 6DOF virtual reality includes a reconfiguration unit 910, a processing unit 920, and a blending unit 930

The reconfiguring unit 910 reconfigures 360 images to three-dimension (3D) images to recover 3D geometric information, and reconfigures a virtual data map in which the multiple 360 images are integrated into one image.

The reconfiguration unit 910 may perform the 3D reconfiguration procedure, such as a structure from motion (SfM) procedure serving as a pre-processing procedure, to recover the 3D geometric information of scenes, which are necessary for view-synthesis, from the multiple 360 images. In this case, the estimated 3D geometric information may include a point cloud for 360 images, a 3D mesh based on the point cloud, and an external parameter group (a camera location) of a camera, which indicates the posture of the camera.

The reconfiguration unit 910 may reconfigure a virtual data map in which all 3D geometric information is unified.

According to an embodiment of the present disclosure, the reconfiguration unit 910 of the system 900 for synthesizing a novel-view image based on multiple 360 images for 6DOF virtual reality may reconfigure a sphere mesh having a triangular surface and a plurality of vertexes by sub-dividing a Icosahedron sphere several times, in association with the 360 images. The sphere mesh having numerous vertexes is used to express the moving of a pixel in the vertex warping process.

The processing unit 920 generates a view image corresponding to the viewpoint of the user by applying a view synthesis algorithm of the projection & vertex warping process by using a reference image closes to a viewpoint extracted from the virtual data map.

The processing unit 920 may employ a novel view synthesis algorithm, based on at least one reference image after acquiring the virtual data map of the schemes. The reference image closet to the novel viewpoint should have a view the most view to a novel view. In this regard, a method in which the processing unit 920 uses the closest single reference image will be described below.

In more detail, the processing unit 920 may include an acquisition unit (not illustrated) to acquire a viewpoint corresponding to each vertex of the virtual data map by using the reference image mapped to the reference sphere, and acquire a position, in which the vertex is moved, as the viewpoint is projected to the novel sphere, a pixel unit (not illustrated) to induce the movement of pixels by moving the vertexes of the reference sphere to the acquired position, and a generator (not illustrated) to generate a view image corresponding to a field-of view at a user viewpoint by positioning the camera into the novel sphere.

In this case, the acquiring unit may use a single reference image closes to the viewpoint or two reference images closes to the viewpoint.

For example, referring to FIG. 4, the processing unit 920, which performs projection & vertex warping using the single reference image, may select an image closest to the novel view as a reference image, may map the reference image to the sphere mesh having a triangular surface and a plurality of vertexes by sub-dividing a Icosahedron sphere several times. When light is radiated from the center of a sphere through each vertex of the reference image, a novel viewpoint may be reflected (sun-casted), and a next reference vertex may be transformed to a vertex of a sphere of a novel viewpoint. As the vertexes are transformed, all pixels are mapped to the sphere, the sphere is moved for a novel view, and the novel view is generated.

Accordingly, the processing unit 920 may project the viewpoint to a novel sphere, acquire the position, to which the vertex is moved, and move the vertexes of the reference images to the relevant position, thereby inducing the movement of the pixels. Thereafter, the processing unit 920 may generate the novel view image through the sphere matched to the field of view of the display.

For another example, the processing unit 920, which performs the projection & vertex warping by using two reference images, may acquire viewpoints in a three-dimension (3D) model corresponding to a vertex of reference image 1 and a vertex of reference image 2, and project the viewpoints to the novel sphere, thereby acquiring positions to which the vertexes are moved. Thereafter, the processing unit 920 may induce the movement of pixels by applying 360 images to the positions, that is, moving the vertexes of reference image 1 and reference image 2. Accordingly, at the final image, the processing unit 920 may position the camera into the novel sphere, and may generate the novel view image corresponding to the field-of-view at the user viewpoints.

The blending unit 930 blends view images for 6DoF through a section formula for inner split based on the distance between the position of the reference image and the position of the viewpoint.

The blending unit 930 may consider at least two reference images, and use a weighted blending scheme for blending pixels inversely proportional to the distance, to prevent a screen image, which is generated when the reference image is changed, from being switched.

In addition, the blending unit 930 may acquire the distance between the novel sphere and reference sphere 1, and the distance between the novel sphere and reference 2, and then may calculate the pixel values of the view image at the final stage through the section formula to perform the weighted blending for the pixels. In this case, the section formula, which is Equation 1 as described above, may be an equation for weighted blending.

It is obvious to those skilled in the art that the system according to the present disclosure includes all features described with reference to FIGS. 1 to 8, even though the system of FIG. 9 is not fully described.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may perform an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be recorded in one or more computer-readable storage medium.

The method according to an embodiment may be implemented in the form of a program instruction and may be recorded in a computer-readable recording medium. The computer-readable storage medium may also include program instructions, data files, data structures, or a combination thereof. The program instructions recorded in the medium may be designed and configured specially for the embodiment or may be known and available to those skilled in computer software. The computer-readable storage medium may include a hardware device, which is specially configured to store and execute program instructions, such as magnetic media (e.g., a hard disk drive and a magnetic tape), optical media (e.g., CD-ROM and DVD), magneto-optical media (e.g., a floptical disk), a read only memory (ROM), a random access memory (RAM), or a flash memory. Examples of program instructions include not only machine language codes created by a compiler, but also high-level language codes that are capable of being executed by a computer by using an interpreter or the like. The described hardware devices may be configured to act as one or more software modules to perform the operations of the above-described embodiments, or vice versa.

While embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

1. A method for synthesizing a novel-view image based on multiple 360 images for 6DOF virtual reality, the method comprising:
performing a 3D reconfiguration procedure for the 360 images to recover 3D geometric information, and to reconfigure a virtual data map in which the multiple 360 images are integrated into one image;
producing a view image corresponding to a viewpoint of a user by applying a view synthesis algorithm of projection & vertex warping process using a reference image which is closest to a viewpoint extracted from the virtual data map; and
blending view images for 6DoF through a section formula for inner split based on a distance between a position of the reference image and a position of the viewpoint.

2. The method of claim 1, wherein the reconfiguring of the virtual data map includes:
reconfiguring the virtual data map, which is a reference sphere of a sphere mesh having a triangular surface and a plurality of vertexes by subdividing a Icosahedron sphere several times, with respect to the 360 images.

3. The method of claim 2, wherein the reconfiguring of the virtual data map includes:
performing the 3D reconfiguration in a structure from motion (SfM) scheme for view synthesis based on the multiple 360 images; and
reconfiguring the virtual data map in which the 3D geometric information is integrated into one image.

4. The method of claim 3, wherein the 3D geometric information includes:
a point cloud for the 360 images, a 3D mesh based on the point cloud, and an external parameter group (a camera location) of a camera, which indicates a posture of the camera.

5. The method of claim 2, wherein the producing of the view image includes:
acquiring the viewpoint corresponding to each vertex of the virtual data map by using the reference image mapped to the reference sphere, and acquiring a position, in which the vertex is moved, as the viewpoint is projected to a novel sphere;
inducing movement of pixels by moving vertexes of the reference sphere to the acquired position; and
producing the view image corresponding to a field-of view at a user viewpoint by positioning a camera into the novel sphere.

6. The method of claim 5, wherein the acquiring of the viewpoint and the position includes:
using a single reference image closest to the viewpoint or two reference images closes to the viewpoint.

7. The method of claim 5, wherein the blending of the view image includes:
employing a weighted blending scheme for blending pixels inversely proportional to the distance, with respect to at least two reference images, to prevent an environment of the reference image from being switched.

8. The method of claim 7, wherein the blending of the view image includes:
calculating pixel values of the view image at the final stage through the section formula, after acquiring a distance between the novel sphere and the reference sphere to perform the weighted blending scheme for the pixels.

9. The method of claim 8, wherein the section formula is an equation for acquiring weighted blending.

10. A computer program stored in a computer-readable medium to execute a method for synthesizing a novel-view image based on multiple 360 images for 6DOF virtual reality, wherein the method for synthesizing the novel-view image based on the multiple 360 images for the 6DOF virtual reality, includes:
performing a 3D reconfiguration procedure for the 360 images to recover 3D geometric information, and to reconfigure a virtual data map in which the multiple 360 images are integrated into one image;
producing a view image corresponding to a viewpoint of a user by applying a view synthesis algorithm of projection & vertex warping process using a reference image which is closest to a viewpoint extracted from the virtual data map; and
blending view images for 6DoF through a section formula for inner split based on a distance between a position of the reference image and a position of the viewpoint.

11. A system for synthesizing a novel-view image based on multiple 360 images for 6DOF virtual reality, the system comprising:
a reconfiguring unit configured to perform a 3D reconfiguration procedure for the 360 images to recover 3D geometric information, and to reconfigure a virtual data map in which the multiple 360 images are integrated into one image;
a processing unit configured to generate a view image corresponding to a viewpoint of a user by applying a view synthesis algorithm of projection & vertex warping process using a reference image which is closest to a viewpoint extracted from the virtual data map; and
a blending unit configured to blend view images for 6DoF through a section formula for inner split based on a distance between a position of the reference image and a position of the viewpoint.

12. The system of claim 11, wherein the reconfiguring unit reconfigures the virtual map, which is a reference sphere of a sphere mesh having a triangular surface and a plurality of vertexes by subdividing a Icosahedron sphere several times, with respect to the 360 images.

13. The system of claim 12, wherein the reconfiguring unit performs the 3D reconfiguration in a structure from motion (SfM) scheme for view synthesis based on the multiple 360 images, and reconfigures the virtual data map in which the 3D geometric information is integrated into one image.

14. The system of claim 12, wherein the processing unit includes:
an acquiring unit configured to acquire the viewpoint corresponding to each vertex of the virtual data map by using the reference image mapped to the reference sphere, and acquire a position, in which the vertex is moved, as the viewpoint is projected to a novel sphere;
a pixel unit configured to induce movement of pixels by moving vertexes of the reference sphere to the acquired position; and
a generator configured to generate the view image corresponding to a field-of view at a user viewpoint by positioning a camera into the novel sphere.

15. The system of claim 14, wherein the acquiring unit uses a single reference image closest to the viewpoint or two reference images closes to the viewpoint.

16. The system of claim 14, wherein the blending unit employs a weighted blending scheme for blending pixels inversely proportional to the distance, with respect to at least two reference images, to prevent an environment of the reference image from being switched.

17. The system of claim 16, wherein the blending unit calculates pixel values of the view image at the final stage through the section formula, after acquiring a distance between the novel sphere and the reference sphere to perform the weighted blending scheme for the pixels.
